(19) United States
(12) Patent Application Publication
(10) Pub. No.: US 2025/0185802 A1
(43) Pub. Date: Jun. 12, 2025

(54) INFLATABLE TABLE FOR AIRPLANE TRAYS

(71) Applicant: SPENCE VENTURES INC., Port Moody (CA)

(72) Inventor: Joshua Isaiah Spence, Port Moody (CA)

(73) Assignee: SPENCE VENTURES INC., Port Moody, BC (CA)

(21) Appl. No.: 18/530,396

(22) Filed: Dec. 6, 2023

(51) Int. Cl. A47B 31/06; A47B 3/00; A47B 13/16; B64D 11/06

(52) U.S. Cl. CPC A47B 31/06; A47B 3/00; A47B 13/16; B64D 11/0638

(57) ABSTRACT

An inflatable portable table that is configured to be releasably coupled to airplane seat trays in their folded down position. The present invention includes a body that is elongated and rectangular in shape being configured to be inflated to a high pressure so as to provide a rigid support surface. The body of the present invention includes an upper surface wherein the upper surface has formed therein a plurality of cupholder members. The lower surface of the body includes a securing strap that extends the length of the body and operably engage the trays securing the body thereto. The upper surface includes a perimeter rail member wherein the perimeter rail member is at a height above that of the upper surface in order to retain objects thereon. Locking members are further provided on the lower surface and are configured to releasably couple to the trays.

### FIELD OF THE INVENTION

The present invention relates generally to portable tables, more specifically but not by way of limitation, a high-pressure inflatable table that is configured to be inflated and subsequently secured across at least two airplane trays that are in their down position wherein the present invention provides an expanded surface for working or other activities.

### BACKGROUND

Traveling is typically fraught with various challenges that can include but is not limited to traffic, airport logistics and travel delays due to various reasons. Hundreds of millions of people each year travel by airlines to their desired destination either for work or for leisure. While most airlines offer first class service that include expanded amenities, approximately ninety percent of the seating capacity of the airplane is coach style seating. While this seating provides the necessary space required to travel, conventional airplane seating does have several drawbacks,

One significant drawback for airplane seating is the available fold down tray. As is known in the art, the fold down tray is hingedly secured to the rear of the seat in front of the airplane seat and is operable to be folded to a perpendicular position for use thereof. One problem with the conventional airplane tray is the size is not much larger than a conventional laptop. If a user is trying to utilize a laptop and have room for additional items this cannot be achieved. Additionally, the airplane trays are secured to each seat and are not operably coupled to each other in the folded down position. Many times families or friends will travel and sit together and the airplane trays do not provide a sufficient surface area for games or other activities.

Accordingly, there is a need for an airplane tray table that is configured to be releasably secured to airplane trays once in their folded down position wherein the present invention provides an expanded work surface for work or leisure activities.

### SUMMARY OF THE INVENTION

It is the object of the present invention to provide an airplane tray table that is configured to be secured to at least two airplane seat trays in their folded down position wherein the present invention includes a body that is generally rectangular in shape.

Another object of the present invention is to provide an airplane tray table operable to provide an expanded support surface for airplane trays in their folded down position wherein the body of the present invention is configured to be inflated at a high pressure.

A further object of the present invention is to provide an airplane tray table that is configured to be secured to at least two airplane seat trays in their folded down position wherein the body of the present invention includes an upper surface wherein the upper surface includes a raised perimeter edge circumferentially present on the body.

Yet a further object of the present invention is to provide an airplane tray table operable to provide an expanded support surface for airplane trays in their folded down position wherein the upper surface of the body of the present invention includes cupholder recesses configured to receive and retain a cup or glass therein.

Still another object of the present invention is to provide an airplane tray table that is configured to be secured to at least two airplane seat trays in their folded down position wherein the bottom of the body includes retention members.

An additional object of the present invention is to provide an airplane tray table operable to provide an expanded support surface for airplane trays in their folded down position wherein the retention members are configured to be releasably secured to the airplane seat trays.

Yet a further object of the present invention is to provide an airplane tray table that is configured to be secured to at least two airplane seat trays in their folded down position wherein the body of the present invention is configured to be transported in a bag or similar item in its deflated state.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the present invention operably coupled to exemplary airplane seat trays; and

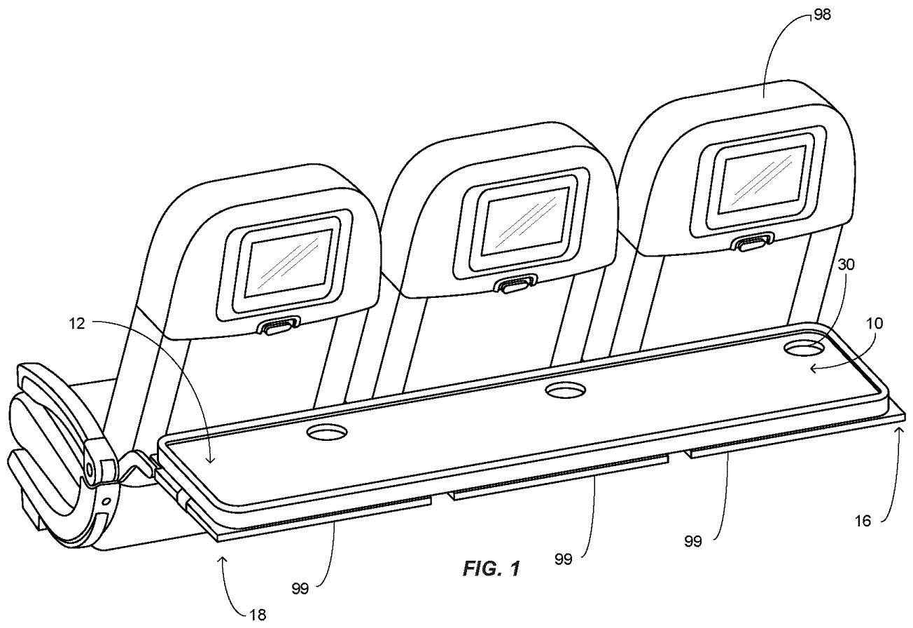

FIG. 2 is a bottom view of the present invention.

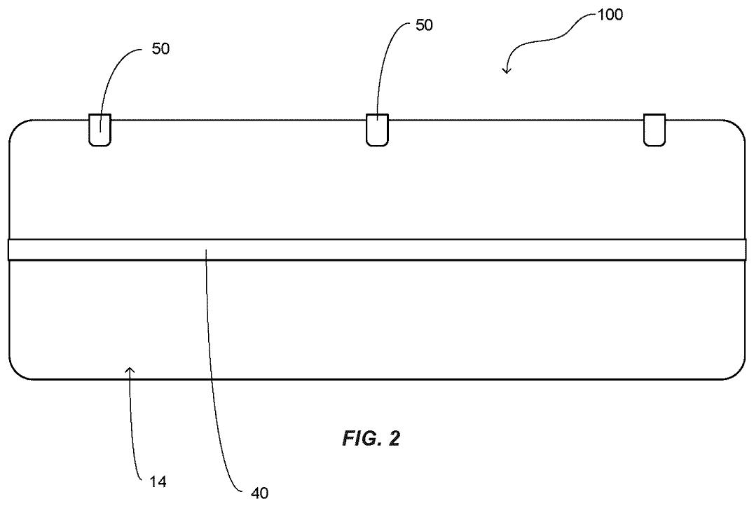

### DETAILED DESCRIPTION

Referring now to the drawings submitted herewith, wherein various elements depicted therein are not necessarily drawn to scale and wherein through the views and figures like elements are referenced with identical reference numerals, there is illustrated a portable table 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the portable table 100 includes a body 10 wherein the body 10 includes an upper surface 12, a lower surface 14, first end 16 and second end 18. The body 10 is manufactured from a rubberized synthetic fabric or other suitable material and is configured to be inflated to a high pressure so as to provide a rigid surface during use thereof. It should be understood within the scope of the present invention that the portable table 100 could be inflated with an external air pump or incorporate an integrated air pump. It should be understood within the scope of the present invention that the body 10 is inflated to at least 100 psi in order to establish sufficient rigidity. The body 10 in its preferred embodiment is elongated and rectangular in shape. The application for the portable table 100 is to be releasably secured to the trays 99 that fold down from airplane seats 98. While the Figures submitted herewith illustrate the portable table 100 being operably coupled to three trays 98, it should be understood within the scope of the present invention that the body 10 could be provided in a size so as to operable couple to only two trays 99. It should be further understood within the scope of the present invention that the body 10 could be configured so as to inflate to alternate thicknesses.

The body 10 includes a perimeter rail member 20 wherein the perimeter rail member 20 is integrally formed as part of the body 10. The perimeter rail member 20 extends upward above the upper surface 12 of the body 10 so as to inhibit objects placed on the upper surface 12 from falling of the upper surface 12. It should be understood within the scope of the present invention that the perimeter rail member 20 could be provided in alternate heights. The body 10 has integrally formed therein cupholder members 30. The cupholder members 30 are annular in shape having a cavity sufficient to receive and retain a beverage vessel therein. It is contemplated within the scope of the present invention that the body 10 could be provided with as few as one cupholder member 30 or more than three cupholder members 30 as is illustrated herein.

Secured to the lower surface 14 of the body 10 is securing strap 40. Securing strap 40 extends the length of the body 10 from the first end 16 to second end 18. The securing strap 40 is manufactured from a suitable material such as but not limited to nylon. The securing strap 40 is configured to releasably secure the body 10 to the trays 99. Retaining members 50 are further provided and are secured to the lower surface 14 of the body 10. The retaining members 50 are secured along an edge of the body 10 and provide an alternate technique to releasably secure the body 10 to the trays 99. While three retaining members 50 are illustrated herein, it is contemplated within the scope of the present invention that the body 10 could have as few as one retaining member 50. Furthermore, it should be understood within the scope of the present invention that the body 10 could employ alternate elements to facilitate releasably securing the body 10 to the trays 99.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An inflatable portable table configured to be releasably secured to airplane seat trays wherein the inflatable portable table comprises:
a body, said body being rectangular in shape, said body having a first end and a second end, said body having a lower surface and an upper surface, said body being configured to be inflated;
at least one cupholder member, said at least one cupholder member being annular in shape having a cavity sufficient to receive and retain a beverage vessel therein;
a perimeter rail member, said perimeter rail member being integrally formed with said body being present around a perimeter edge of the body, said perimeter rail member extending above the upper surface of said body; and
a securing strap, said securing strap being secured to said first end and said second end of said body adjacent the lower surface of said body, said securing strap configured to releasably secure said body to the airplane seat trays.

2. The inflatable portable table configured to be releasably secured to airplane seat trays as recited in claim 1, and further including at least one retaining member, said at least one retaining member being secured to the lower surface of said body, said at least one retaining member configured to releasably secure to the airplane seat tray.

3. The inflatable portable table configured to be releasably secured to airplane seat trays as recited in claim 2, wherein said body is configured to be inflated to alternate thicknesses.

4. The inflatable portable table configured to be releasably secured to airplane seat trays as recited in claim 3, wherein said body is configured to be inflated to a high pressure so as to create a rigid body.
